(19) United States
(12) Patent Application Publication
(10) Pub. No.: US 2006/0238920 A1
(43) Pub. Date: Oct. 26, 2006

(54) Transportation system for a disk-like object and system for inspecting disk-like object

(75) Inventor: Thomas Krieg, Solms (DE)

Correspondence Address: HOUSTON ELISEEVA, 4 MILITIA DRIVE, SUITE 4, LEXINGTON, MA, 02421, US

(73) Assignee: Vistec Semiconductor Systems GmbH, Wetzlar (DE)

(21) Appl. No.: 11/389,821

(22) Filed: Mar. 27, 2006

(30) Foreign Application Priority Data
Apr. 26, 2005 (DE) DE 102005019330.7

(51) Int. Cl. G11B 23/03

(52) U.S. Cl. 360/133

(57) ABSTRACT

A transportation system for a disk-like object and a system for inspecting a disk-like object are disclosed. The transportation system comprises a first element (10) and a second element (20) which are arranged in such a way that between the first element (10) and the second element (20) a free space is formed. The first element (10) has a surface (10a) facing the free space, the second element (20) also has a surface (20a) facing the free space. A plurality of openings (24) is formed in the two surfaces (10a, 20a), through which pressurized air exits in order to hold the disk-like object (11) in the free space (30) in a levitating manner.

### RELATED APPLICATIONS

This application claims priority to German application serial number DE 10 2005 019 330.7 on Apr. 26, 2005, which is incorporated herein by reference in its entirety.

### FIELD OF THE INVENTION

The present invention relates to a transportation system for a disk-like object. The present invention also relates to a system for inspecting a disk-like object wherein the system comprises a transportation system for the disk-like object.

### BACKGROUND OF THE INVENTION

In semiconductor manufacturing, wafers are sequentially processed during the manufacturing process in a great number of processing steps. As integration densities are increased, the requirements as to the quality of the structures formed on the wafers become more stringent. As a result, the requirements demanded of the handling system of a disk-like object or wafer are also increased.

U.S. patent application 2004/0187280 A1 discloses an apparatus which is suitable for attracting work pieces, wherein the work piece is a wafer. The wafer is attracted according to the Bernoulli principle and can then be transported in a contactless way. The wafers are taken out of a support with the aid of the Bernoulli principle, and the support is moved in exactly the same way as the arm of the apparatus holding the wafer for transportation.

U.S. Pat. No. 5,080,549 discloses an apparatus for handling a wafer with the aid of the Bernoulli principle. The apparatus is used to pick up and depose wafers. The apparatus comprises a plate having a plurality of oblique apertures and a central aperture in order to create suction with the aid of gas exiting from the apertures in order to lift the wafer.

U.S. Pat. No. 4,029,351 also discloses an apparatus for handling a wafer with the aid of the Bernoulli principle. The Bernoulli head comprises a central aperture, and three further apertures arranged about the central aperture. The gas flow from the central aperture essentially causes the lifting force for the wafer. The three further apertures are used to correct the position of the wafer. It is thus ensured that there is no contact between the Bernoulli head and the wafer.

Japanese patent application JP 2004.235622 discloses a transportation device according to the Bernoulli principle comprising a transportation head for the contactless transport of the disk-like object. Further the transportation device is configured in such a way that when the air flow fails, a falling of the disk-like object is avoided. A plurality of holding means are provided along the circumference of the disk-like object which are supposed to prevent the disk-like object from falling.

U.S. Pat. No. 6,559,938 discloses an apparatus for the simultaneous inspection of the front and back sides of a wafer with respect to defects. The wafer rests on a table which has an open channel having a length corresponding to the diameter of the wafer. A detector moves in the channel taking an image of part of the wafer. In order to be able to image the entire surface of the wafer, the wafer is rotatable on the table. The friction between the table and the wafer is reduced by corresponding air bearings. Simultaneous imaging or inspection of the entire surface of the front and back side of the wafer is not possible with this apparatus.

U.S. Pat. No. 6,747,464 B1 discloses a wafer holder enabling the back surface of the wafer to be monitored and measurements to be taken on the front side of the wafer. The wafer holder is used in machines for automatically inspecting a wafer. The wafer holder is configured in such a way that the front side and the back side of the wafer are nearly fully accessible from both sides. Simultaneous imaging of the front side and the back side of the wafer is not possible with this wafer holder.

U.S. patent application No. 2004/0087146 discloses an annular wafer holder. The wafer holder has a holding ring for the wafer and is open at the top so that the wafer can be fully inspected from one side. The other side of the wafer rests on a supporting frame in which an inspection window is formed through which a fraction of the side of the wafer can be inspected which rests on the holding frame. Simultaneous and full inspection of the front and back sides of the wafer is not possible with this wafer holder.

### SUMMARY OF THE INVENTION

It is therefore an object of the present invention to provide a transportation system for a disk-like object enabling a contact-free and secure transport of the disk-like object.

The object is achieved by a transportation system having the features according to claim 1.

It is another object of the present invention to provide a system for inspecting a disk-like object enabling the disk-like object to be imaged from at least one side in a secure and non-destructive way.

The present object is achieved by a system having the features according to claim 11.

Preferably a transportation system for a disk-like object has a first element and a second element arranged in such a way that a free space is formed between the first and second elements. The first element has a surface facing the free space and a second element also has a surface facing the free space. A great number of openings is formed in the two surfaces through which pressurized air exits in order to hold the disk-like object in the space in a levitating manner. In holding the disk-like object in a levitating manner, Bernoulli effects are no doubt also involved.

In each of the first and second elements a recess is formed, wherein a detector element is associated with each recess. The detector element is a linear diode array. The scan line can preferably be formed as a linear diode array.

The front and back sides of the disk-like object can be imaged using the two detector elements. At least one feeding unit for pressurized air is associated with the first element, and at least one feeding unit for pressurized air is also associated with the second element.

The first and second elements each have a protrusion formed on them which serve for picking up a disk-like object from a storage container and to depose a disk-like object in a storage container.

A free space is formed by the first and second elements. An end stop which is moveable by a servo motor is formed in the free space ensuring a constant transportation velocity of the disk-like object.

The protrusion of the first element and the second element each have a front end, wherein on the front end the first and second element have a funnel shaped entry way for the disk-like object.

A system for inspecting a disk-like object is also provided. This system comprises a transportation system for the disk-like object and consists of a first element and a second element arranged in such a way that between the first and second elements a free space is formed. The first element has a surface facing the free space and the second element also has a surface facing the free space, wherein a plurality of openings is formed in the two surfaces through which pressurized air exits in order to hold the disk-like object in the free space in a levitating manner.

In each of the first and second elements a recess is formed, and a detector element is associated with each recess, so that it is possible to simultaneously image the front and back sides of the disk-like object. The detector element can be a linear diode array.

At least one feeding unit for pressurized air is associated with the first element, and at least one feeding unit for pressurized air is also associated with the second element.

Each of the first and second elements have a protrusion formed on them which serves for picking up a disk-like object from a storage container and to depose a disk-like object in a storage container. The storage container comprises at least one FOUP from and to which the disk-like objects are transportable.

An end stop which can be moved by a servo motor is formed in the free space ensuring a constant transportation velocity of the disk-like object in the free space and therefore transporting the disk-like object at constant velocity past the detector elements.

The disk-like object is a wafer on a semiconductor substrate. The disk-like object can also be a wafer on a glass substrate. The disk-like object can also be a mask for lithography processes. It is also conceivable for the disk-like object to be a flat panel display.

The linear detector array can have an integrated optics and an integrated illumination. The first and second detector elements can have at least the width of the planar object.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The subject matter of the present invention is schematically shown in the drawings and will be described with reference to the figures, in which:

FIG. 1 shows a schematic representation of a system for inspecting a disk-like object;

FIG. 2 is a perspective view of a system for imaging at least one surface of a disk-like object;

FIG. 3 is another perspective view of the system of FIG. 2;

FIG. 4 is a side view of the elements forming a free space in which the disk-like object is held in a levitating manner;

FIG. 5 is an enlarged view of the area indicated as A and surrounded by a broken-line circle in FIG. 4;

FIG. 6 is an enlarged view of the area indicated as B and surrounded by a broken-line circle in FIG. 4;

FIG. 7 is a perspective view of the transportation system during pick-up of a disk-like object into the transportation system;

FIG. 8 is a top plan view of a surface of an element facing the disk-like object;

FIG. 9 is a top plan view of a first possible embodiment of a detector element for the detector unit;

FIG. 10 is a top plan view of a first possible embodiment of a detector element for the detector unit; and

FIG. 11 is a side view of the detector unit.

### DETAILED DESCRIPTION OF THE PREFERRED EMBODIMENTS

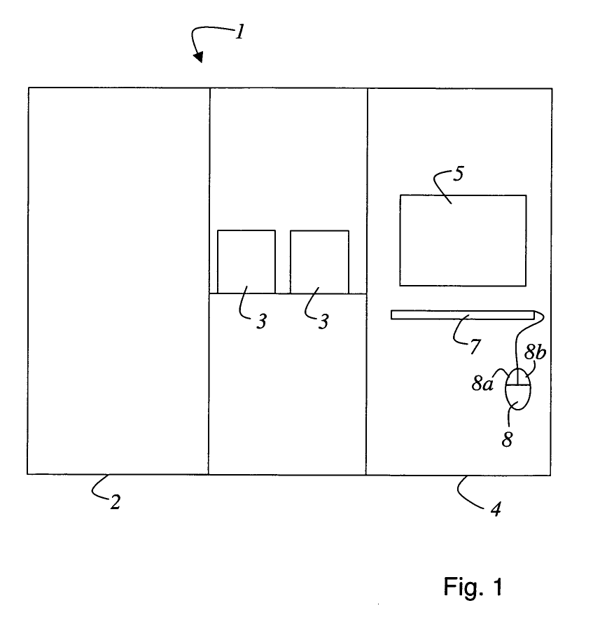

With reference to FIG. 1, a system 1 for inspecting disk-like objects is shown. System I can comprise a plurality of modules 2 or 4, which can be composed according to the user's specifications and the user's inspection requirements. System 1 can comprise, for example, a module 2 for macro-inspection. In addition, system 1 can comprise a module 4 for micro-inspection of disk-like objects. The disk-like objects are transferred to apparatus 1 with the aid of at least one container 3. System 1 comprises a display 5 on which various user interfaces can be shown. A keyboard 7 is also associated with system 1 enabling the user to effect inputs to the apparatus to therefore change the control of system 1 in a desired way. A further input unit 8 via which the user can effect inputs can also be associated with keyboard 7 enabling the user to control a cursor on display 5. The input unit 8 comprises a first input element 8a and a second input element 8b. In a preferred embodiment, input unit 8 is configured as a computer mouse. If system 1 for inspecting disk-like objects consists of a module 2 for micro-inspection, the lateral displacement of the XYZ stage can be shown on display 5. To achieve this, the XYZ stage is incorporated in system 1 or module 2, and its displacement is determined by a plurality of recorded individual images.

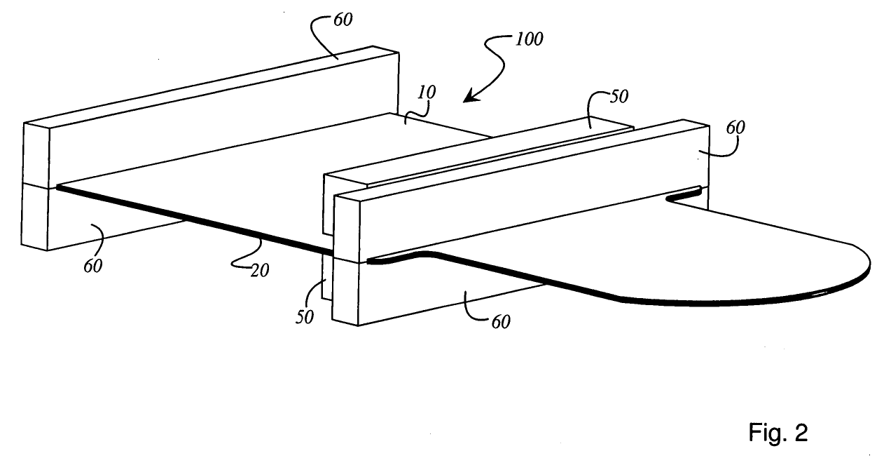

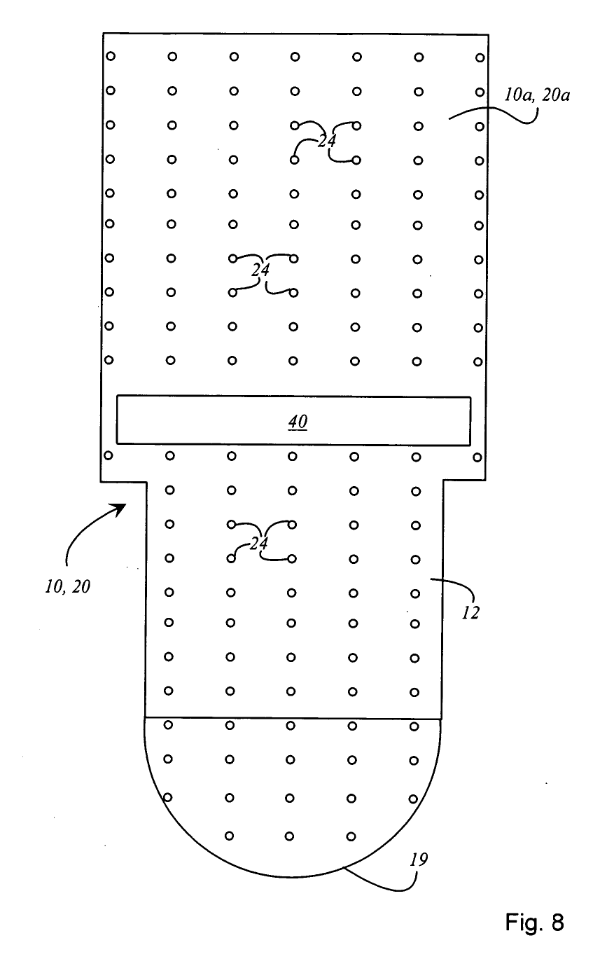

FIG. 2 is a perspective view of an apparatus 100 for imaging at least one surface 11a of a disk-like object 11. The apparatus or the transportation system consists of a first element 10 and a second element 20 arranged in such a way that free space 30 is formed between the first element 10 and the second element 20. The first element 10 has a surface 10a facing the free space 30. The second element 20 also has a surface 20a facing the free space 30. A recess 40 is formed in the first element 10 and the second element 20 (see FIG. 8). Each recess 40 has a detector element 50 associated with it. At least one feeding unit 60 for pressurized air is associated with first element 10, and at least one feeding unit 60 for pressurized air is associated with the second element 20.

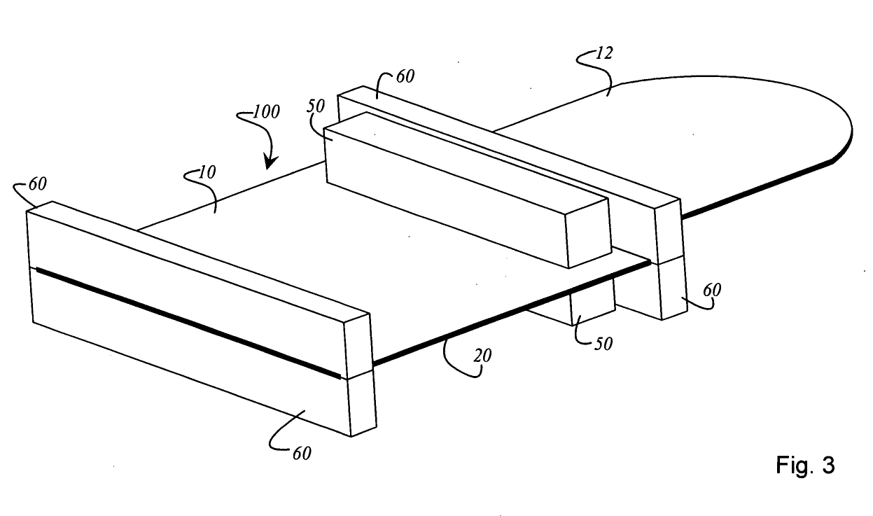

FIG. 3 shows another perspective view of the system of FIG. 2. The first element 10 and the second element 20 each have a protrusion 12 formed on them. Protrusion 12 is for picking up a disk-like object 11 from a storage container and for deposing a disk-like object 11 in a storage container.

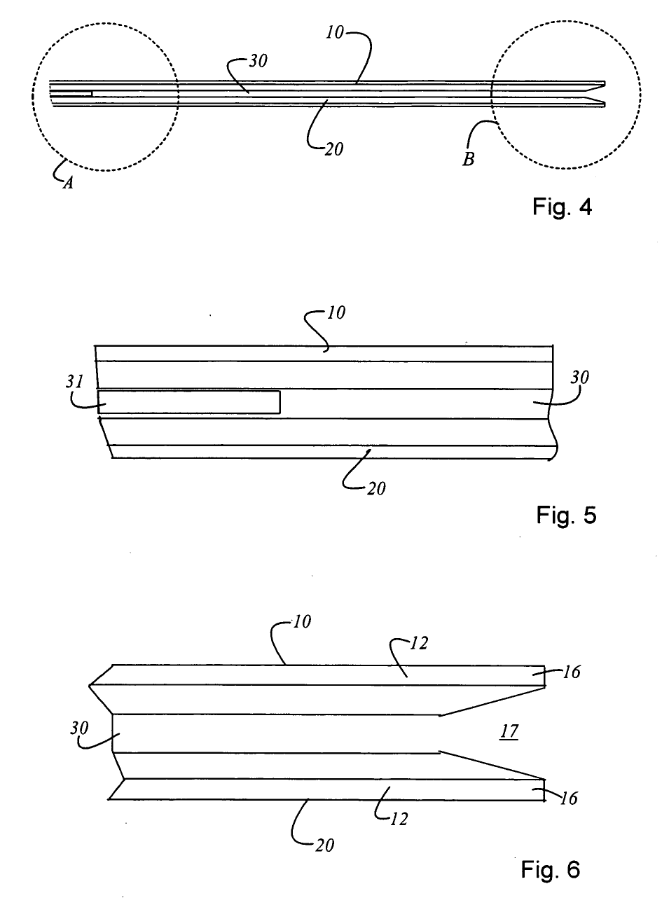

FIG. 4 is a side view of the first and second elements 10 and 20 forming the free space 30 in which the disk-like object 11 is held or transported in a levitating manner. The free space between the first and second elements 10 or 20 is dimensioned in such a way that the disk-like object 11 is held with sufficient play between the first and second elements 10 and 20. The outer space of the first element 10 and the second element 20 is dimensioned such that the transportation system can take the disk-like object 11 from a storage receptacle or container suitable for the disk-like objects 11.

FIG. 5 is an enlarged view of the area indicated as A in FIG. 4 and surrounded by a broken-line circle in FIG. 4. An end stop 31 which can be moved by a servo motor is formed in free space 30, thereby ensuring a constant transportation velocity of the disk-like object 11 in the free space. As shown in FIG. 8, each element 10 and 20 has a plurality of openings formed on its surface 10a and 20a, respectively, facing the disk-like object 11, through which pressurized air exits, thus holding the disk-like object 11 in free space 30 in a levitating manner. In an embodiment, not shown, the end stop 31, which can be moved by a servo motor, can be eliminated, wherein by suitable control of pressurized air through the openings a transportation movement of the disk-like object 11 can be achieved.

FIG. 6 is an enlarged view of the area indicated as B and surrounded by a broken-line circle in FIG. 4. Protrusion 12 of the first element 10 and the second element 20 has a front end 16. The front end 16 of the first and second elements 10 and 20 together form a funnel shaped entry way 17 for a disk-like object 11. The funnel shaped entry way 17 ensures that the disk-like object 11 can be inserted in the transportation system 100 without damage.

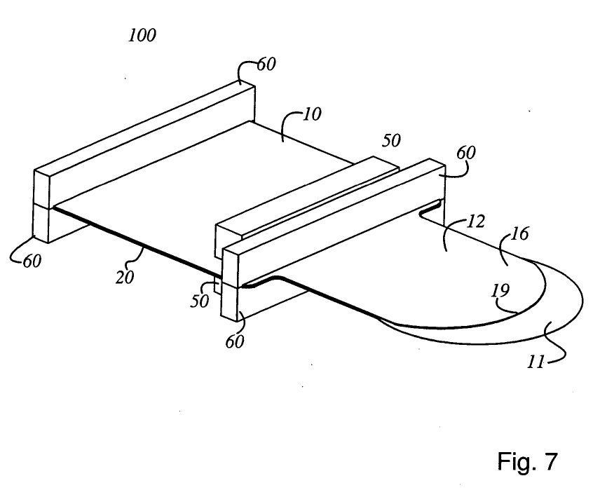

FIG. 7 is a perspective view of the transportation system 100 during imaging of a disk-like object 11 in the transportation system. The disk-like object 11 is received in protrusion 12 of the first and second elements 10 and 20. By the corresponding application of pressurized air to the openings in the first and second elements 10 and 20 the disk-like object 11 can be moved in the free space 30 of the transportation system in a levitating manner. The movement can be supported or limited, for example, by means of the end stop 13, which can be moved by a servo motor. Protrusion 12 can also be provided with a rounded shape 19 at its front end 16, which facilitates picking up the disk-like object 11.

FIG. 8 is a top plan view of a surface 10a or 20a of an element 10 or 20, which faces the disk-like object 11. A plurality of openings 24 is formed in the two surfaces 10a or 20a, through which pressurized air exits to thus hold the disk-like object in the free space 30 in a levitating way. Each of elements 10, 20 has a recess 40 formed in them, through which the detector element is directed on the surface of the disk-like object 11 to be imaged.

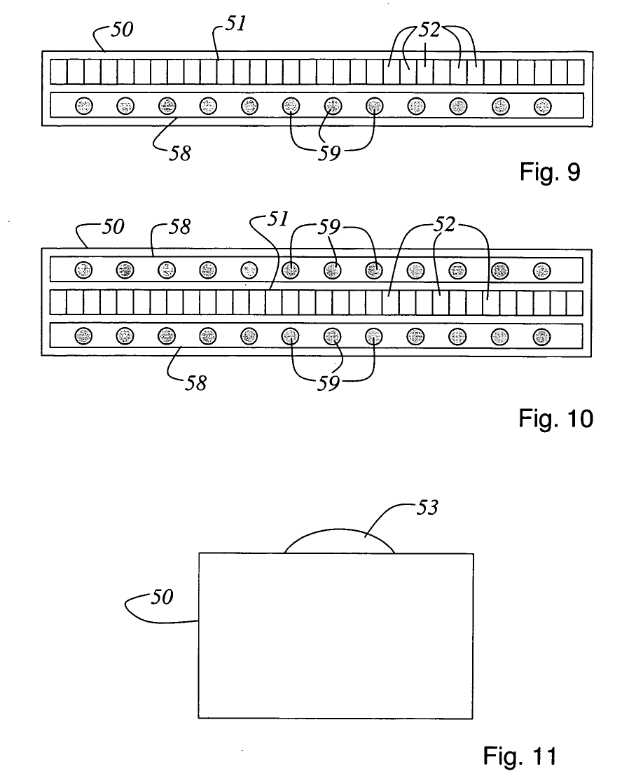

FIG. 9 is a top plan view of a first embodiment of a detector element 50. The detector element 50 has an essentially linear form. In the embodiment shown the detector element 50 comprises at least one linear array 51 of individual detectors 52. Detector element 50 is also provided with an illumination 58 in parallel to the linear array 51. Illumination 58 can be a linear array of a plurality of diodes 59. A suitably dimensioned surface emitter is also conceivable as the illumination 58.

FIG. 10 is a top plan view of a second embodiment of a detector element 50. Detector element 50 has essentially a linear form. An illumination 58 is provided to the right and left of a linear array 51 of individual detectors 52. The illumination 58 can also consist of a linear array of a plurality of diodes 59. A suitably dimensioned surface emitter can also be conceived as the illumination 58.

FIG. 11 shows a side view of the detector element 50. Herein the first and second detector elements 50 comprise a linear array 51 of detectors 52 including at least an integrated optics 53 for imaging the front and back surfaces of disk-like object 11. Moreover, as already described with reference to FIGS. 9 and 10, the first and second detector elements 50 can be provided with an integrated illumination 58.

While this invention has been particularly shown and described with references to preferred embodiments thereof, it will be understood by those skilled in the art that various changes in form and details may be made therein without departing from the scope of the invention encompassed by the appended claims.

What is claimed is:

1. A transportation system for a disk-like object, comprising a first element and a second element, which are arranged in such a way, that a free space is formed between the first element and the second element, wherein the first element has a surface facing the free space, wherein the second element has a surface facing the free space and a plurality of openings formed in the two surfaces, through which pressurized air exits, to hold the disk-like object in the free space in a levitating manner.

2. The transportation system according to claim 1, wherein a recess is formed in each of the first and second elements and a detector element is associated with each recess.

3. The transportation system according to claim 2, wherein the detector element is a linear diode array.

4. The transportation system according to claim 2, wherein the front and back surfaces of the disk-like object is imaged by means of the two detector elements.

5. The transportation system according to claim 1, wherein at least one feeding unit for pressurized air is associated with the first element and at least one feeding unit for pressurized air is associated with the second element.

6. The transportation system according to claim 1, wherein the first element and the second element each have a protrusion formed on them, which is for picking up a disk-like object from a storage container and for deposing a disk-like object in a storage container.

7. The transportation system according to claim 6, wherein the free space formed by the first element and the second element has a gap which corresponds to at least twice the thickness of the disk-like object.

8. The transportation system according to claim 6, wherein the first element and the second element form at least a gap which is smaller than a shelf space in which the disk-like object rests until it is picked up.

9. The transportation system according to claim 1, wherein that the protrusion of the first element and the second element each has a front end and in that at the front end the first and second elements and together form a funnel shaped entry way for the disk-like object.

10. A system for inspecting a disk-like object comprising a transportation system for the disk-like object, with a first element and a second element are arranged in such a way, that a free space is formed between the first element and the second element, wherein the first element has a surface facing the free space and the second element has a surface facing the free space, and a plurality of openings is formed in the two surfaces, through which pressurized air exits, in order to hold the disk-like object in the free space in a levitating manner.

11. The system according to claim 10, wherein a recess is formed in the first element and/or the second element, and in that a detector element is associated with each recess, so that simultaneous imaging of the front and back surfaces of the disk-like object is possible.

12. The system according to claim 11, wherein the detector element is a linear diode array provided with an integrated optics.

13. The system according to claim 11, wherein at least one feeding unit for pressurized air is associated with the first element and at least one feeding unit for pressurized air is associated with the second element.

14. The system according to claim 11, characterized in that the first element and the second element each have a protrusion formed on them, which is for picking up a disk-like object from a storage container and for deposing a disk-like object in a storage container.

15. The system according to claim 11, wherein the free space formed by the first element and the second element has a gap which is at least twice the thickness of the disk-like object.

16. The system according to claim 11, wherein an end stop is movable by a servo motor in the free space, ensuring a constant transportation speed of the disk-like object in the free space and thereby transporting the disk-like object past the detector elements at constant velocity.

17. The system according to claim 11, wherein the protrusion of the first element and the second element each has a front end and in that the front end of the first and second elements and together form a funnel shaped entry way for the disk-like object.

18. The system according to claim 11, wherein the linear detector array has an integrated optic and an integrated illumination.

19. The system according to claim 11, wherein the first and second detector elements have at least the width of the planar object.

20. The system according to claim 11, wherein the transportation system is formed in such a way that it is possible to simultaneously image the front and back surfaces of the disk-like object.
